(19) United States
(12) Patent Application Publication
(10) Pub. No.: US 2024/0103842 A1
(43) Pub. Date: Mar. 28, 2024

(54) Apparatuses, Devices, Methods and Computer Programs for Modifying a Target Application

(71) Applicant: Intel Corporation, Santa Clara, CA (US)

(72) Inventors: Cunming LIANG, Shanghai (CN); Ping YU, Shanghai (CN); Zongmin GU, Shanghai (CN)

(21) Appl. No.: 18/528,921

(22) Filed: Dec. 5, 2023

(30) Foreign Application Priority Data
Sep. 6, 2023 (WO) PCT/CN2023/117269

(51) Int. Cl. G06F 8/65

(52) U.S. Cl. CPC G06F 8/65

(57) ABSTRACT

Examples relate to apparatuses, devices, methods and computer programs for modifying a target application. An apparatus for a computer system comprises memory circuitry, machine-readable instructions, and processor circuitry to execute the machine-readable instructions to launch, using a loader application, a target application, obtain, by the loader application, information on a kernel system call having been made by the target application, and modify, by the loader application and based on the information on the kernel system call having been made by the target application, an instruction of the target application, wherein the modified instruction is configured to trigger an operation being equivalent to the kernel system call, with the operation being equivalent to the kernel system call while avoiding a context switch.

### BACKGROUND

System calls are the primary interface between user-space applications and the kernel in an operating system (OS). When an application needs to access a resource or perform a privileged operation, it makes a system call (short “syscall”), which causes the CPU (Central Processing Unit) to switch from a user mode to a kernel mode and execute the corresponding kernel code to access resources and perform privileged operations. The system call is a useful design for streamlining the interface between a user space and a kernel space. However, it also introduces overhead when switching from kernel space to user space (and vice versa).

In data centers, a common optimization technique is to utilize a so-called “kernel bypass” technology, which enables direct communication between user space and hardware acceleration through specialized I/O (Input/Output) libraries. This approach allows applications to leverage hardware acceleration while reducing CPU load and enhancing overall performance. For instance, DPDK (Data Plane Development Kit) is a collection of libraries and drivers that facilitate network applications to bypass the kernel and fully execute workloads in user space, resulting in faster packet processing and improved network performance. Building upon DPDK, multiple user space TCP/IP (Transmission Control Protocol/Internet Protocol) stacks have been developed, enabling applications to replace the kernel space stack with the user space stack for significant performance gains. Since the TCP/IP stack relies on the POSIX (Portable Operating System Interface) system call interface, intercepting the system call and replacing it with a kernel bypass implementation becomes a simple yet effective method to enhance overall networking performance. System call interception with kernel bypass technology has two major benefits in the data center: One is the performance improvement, and the second is the ability to keep the existing application unchanged without requiring re-compilation of the application.

There are several methods for implementing a system call interception, including dynamic linking, library interposition, “ptrace”, KVM based interception etc. In general, there is no perfect solution for all use cases yet. Some interception methods focus on functionality, but the performance is poor. For example, “ptrace” can be used to trace and debug another process by intercepting the system calls, but “ptrace” itself is also a system call, generating an additional performance overhead. In some cases, the performance of the interception method is good, but it is hard to be applied to all use cases. For example, dynamically linked application can use the LD_PRELOAD instruction to replace the original libc library with an optimized library that uses kernel bypassing. However, this approach cannot function properly with statically linked applications, such as “Go” language applications.

### BRIEF DESCRIPTION OF THE FIGURES

Some examples of apparatuses and/or methods will be described in the following by way of example only, and with reference to the accompanying figures, in which:

FIG. 1a shows a schematic diagram of an example of an apparatus or device for a computer system;

FIG. 1b shows a flow chart of an example of methods for a computer system;

FIG. 2 shows a typical binary layout in a workload in Linux system;

FIG. 3 shows a binary layout after hot patching;

FIG. 4 shows an example hot patching flow;

FIG. 5 shows a block diagram of an electronic apparatus incorporating at least one electronic assembly and/or method described herein;

FIG. 6 illustrates a computing device in accordance with one implementation of the proposed concept; and

FIG. 7 shows an example of a higher-level device application for the disclosed examples.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

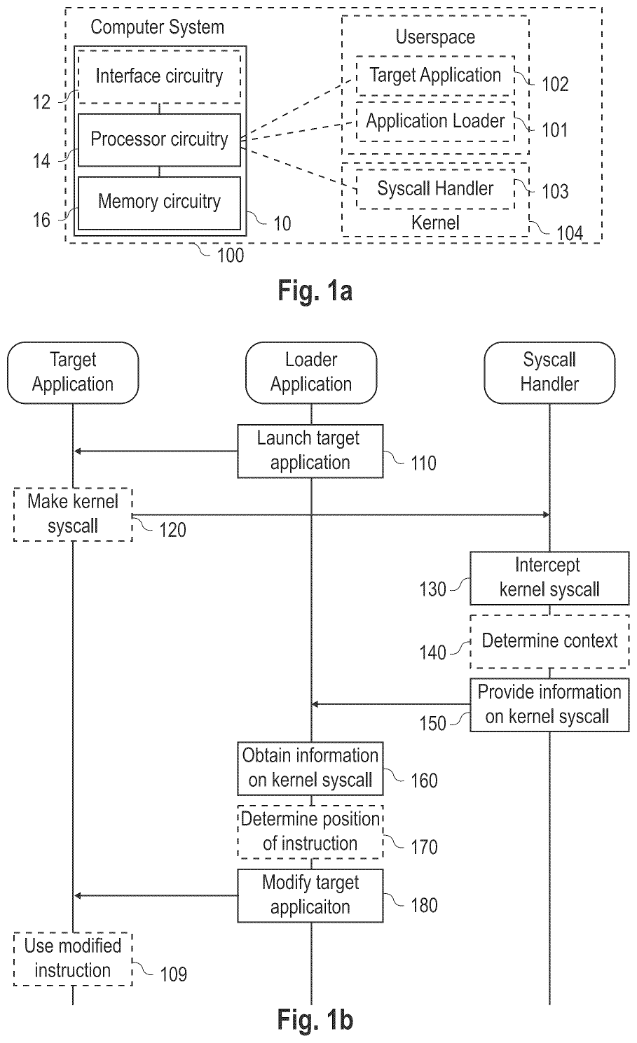

FIG. 1a shows a schematic diagram of an example of an apparatus 10 or device 10 for a computer system 100, and of a computer system 100 comprising such an apparatus 10 or device 10. The apparatus 10 comprises circuitry to provide the functionality of the apparatus 10. For example, the circuitry of the apparatus 10 may be configured to provide the functionality of the apparatus 10. For example, the apparatus 10 of FIG. 1a comprises (optional) interface circuitry 12, processor circuitry 14, and memory circuitry 16. For example, the processor circuitry 14 may be coupled with the interface circuitry 12 and with the memory circuitry 16. For example, the processor circuitry 14 may provide the functionality of the apparatus, in conjunction with the interface circuitry 12 (for communicating with another computer system or entity or with other components of the computer system 100), and the memory circuitry 16 (for storing information, such as machine-readable instructions). Likewise, the device 10 may comprise means for providing the functionality of the device 10. For example, the means may be configured to provide the functionality of the device 10. The components of the device 10 are defined as component means, which may correspond to, or implemented by, the respective structural components of the apparatus 10. For example, the device 10 of FIG. 1a comprises means for processing, which may correspond to or be implemented by the processor circuitry 14, (optional) means for communicating 12, which may correspond to or be implemented by the interface circuitry 12, and means for storing information 16, which may correspond to or be implemented by the memory or storage circuitry 16. In general, the functionality of the processor circuitry 14 or means for processing 14 may be implemented by the processor circuitry 14 or means for processing 14 executing machine-readable instructions. Accordingly, any feature ascribed to the processor circuitry 14 or means for processing 14 may be defined by one or more instructions of a plurality of machine-readable instructions. The apparatus 10 or device 10 may comprise the machine-readable instructions, e.g., within the memory circuitry 16 or means for storing information 16, as shown in FIG. 1a, or within storage circuitry or means for permanently storing information (not shown).

In a first aspect of the present disclosure, the processor circuitry 14 or means for processing 14 is to launch, using a loader application 101, a target application 102. In the first aspect, the processor circuitry 14 or means for processing 14 is to obtain, by the loader application, information on a kernel system call having been made by the target application. In the first aspect, the processor circuitry 14 or means for processing 14 is to modify, by the loader application and based on the information on the kernel system call having been made by the target application, an instruction of the target application. The modified instruction is configured to trigger an operation being equivalent to the kernel system call, with the operation being equivalent to the kernel system call while avoiding a context switch.

In a second aspect of the present disclosure, the processor circuitry 14 or means for processing 14 is to intercept, by a kernel system call handler 103, the kernel system call having been made by the target application 102 having been launched by the loader application 102. In the second aspect, the processor circuitry 14 or means for processing 14 is to provide, by the kernel system call handler, the information on the kernel system call having been made by the target application to the loader application.

FIG. 1b shows a flow chart of an example of corresponding methods for a computer system, e.g., for the computer system 100. According to the first aspect, the method comprises launching 110, by the loader application 101, the target application 102, obtaining 160, by the loader application, information on the kernel system call having been made by the target application, and modifying 180, by the loader application and based on the information on the kernel system call having been made by the target application, an instruction of the target application. According to the second aspect, the method comprises intercepting 130, by the kernel system call handler 103, the kernel system call having been made by the target application 102 having been launched by the loader application 102, and providing 150, by the kernel system call handler, information on the kernel system call having been made by the target application to the loader application.

In the following, the functionality of the apparatus 10, the device 10, the computer system 100, the method and of a corresponding computer program will be illustrated in more detail with reference to the apparatus 10. Features introduced in connection with the apparatus 10 may likewise be included in the corresponding device 10, computer system 100, method and computer program.

Various examples of the present disclosure are based on the finding, that the context switch between user space and kernel space can be avoided when using user-space code to replace kernel functionality. Kernel space and user space are terms used to describe different regions of memory in an operating system (OS) architecture, especially in systems that use a monolithic kernel like Linux or Unix. They serve to separate the kernel (the core part of the operating system) from the user applications to improve security and stability.

Kernel space is the region of memory dedicated to the kernel, which is the core part of the OS responsible for managing the system's resources, such as memory, processor, and peripherals. The code running in kernel space has complete access to the hardware and can execute privileged CPU instructions. Since it operates at a high level of privilege, the kernel can perform tasks like managing hardware devices, scheduling processes, and facilitating communication between hardware and software. User space, by contrast, is the region where user applications run. These applications are restricted in what they can do with the hardware, as they do not have direct access to the system resources. Instead, they usually interact with the kernel through a set of well-defined system calls, which help maintain the system's security and stability. A system call is a request by an application for a service performed by the kernel.

A context switch occurs when the operating system switches the CPU from one process or thread to another. This is necessary when multitasking among multiple processes, when a high-priority process needs to run, or when an application program makes a system call that is being handled by the kernel. A context switch between a user space application and the kernel introduces overhead due to several reasons, such as state saving and restoration, flushing the Translation Lookaside Buffer (TLB), cache pollution, pipeline flushing etc.

To avoid context switches, a kernel bypass mechanism may be used, which is usually implemented as a user-space library that implements functionality equivalent to one or more system calls without involving the kernel (thus avoiding the context switch). For example, a kernel bypass mechanism may enable direct communication between user space and hardware acceleration through a specialized user-space I/O library, which enables interaction with hardware without requiring involvement of the kernel. This approach allows applications to leverage hardware acceleration while reducing CPU load and enhancing overall performance. For instance, DPDK is a collection of libraries and drivers that facilitate network applications to bypass the kernel and fully execute workloads in user space, resulting in faster packet processing and improved network performance. Building upon DPDK, multiple user space TCP/IP stacks have been developed, enabling applications to replace the kernel space stack with the user space stack for significant performance gains.

In other approaches, such libraries have been used as drop-in replacements for dynamically linked applications. A dynamically linked application is a program that relies on shared libraries for some of its functionality. Unlike statically linked applications, which incorporate copies of the required libraries into the executable file itself, dynamically linked applications call upon external library files at runtime. Therefore, instead of using the libraries (such as libc) the dynamically linked applications were initially built against, a kernel bypass-version of the library may be used, which at least partially avoids the use of system calls, instead providing direct communication with the respective hardware. However, this approach is only feasible for dynamically linked applications. For statically linked applications, which incorporate the libraries they are compiled against, this approach cannot be used.

The present disclosure provides an approach that is applicable to both statically and dynamically linked applications, and which may be used to implement a kernel bypassing technique with arbitrary applications. As outlined above, in the present disclosure, two aspects are discussed—the first aspect, which is implemented in user space, and the second aspect, which is implemented in kernel space. As both kernel space and user space are executed in the same computer system, the apparatus may perform both the user space aspect and the kernel space aspect.

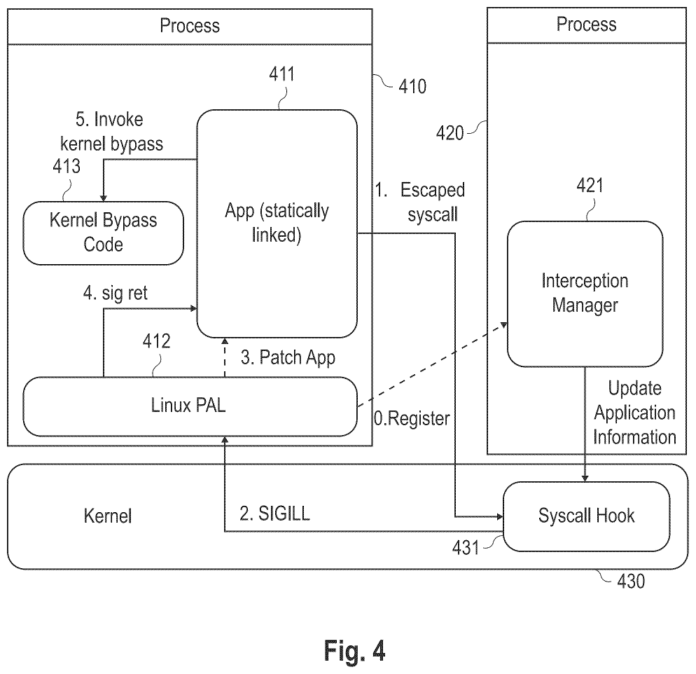

The proposed concept is based on modifying the target application, i.e., the application that is to be adapted to adopt the kernel bypassing mechanism. To perform the modification, the target application is loaded by the loader application, which share the same address space (i.e., the target application is executed in the same virtual address space as the loader application, and vice versa). In other words, the target application may be launched such that the target application shares an address space with the loader application. In addition to launching the target application, the processing circuitry may, using the loader application, register the target application at a kernel system call handler, and load a user-space library for providing the operation being equivalent to the kernel system call. For example, as outlined in connection with FIG. 4, registering the target application may be performed by calling an interception manager being used to control the kernel system call handler.

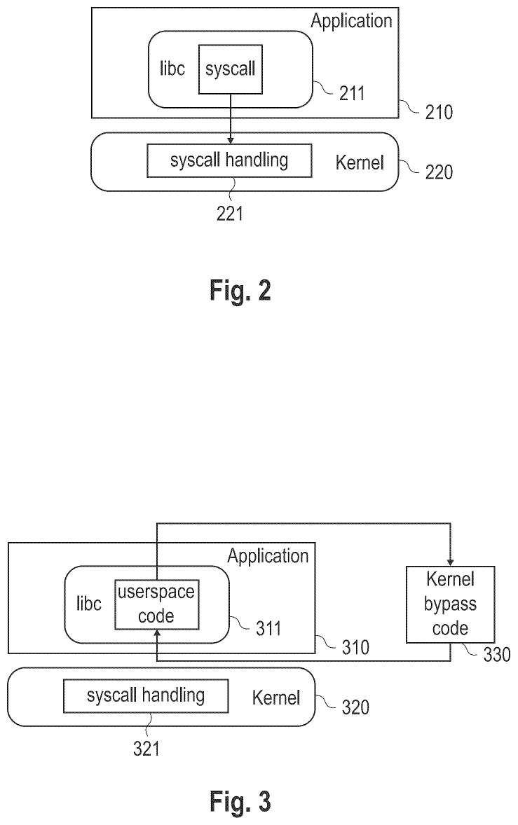

When the target application performs a system call (e.g., by calling a corresponding function in a system library, such as libc), this system call may now be intercepted by the kernel system call handler (i.e., a system call handler implemented in kernel space). A system call handler is a component within an operating system kernel that manages the process of transitioning from user space to kernel space to fulfil system call requests made by user-level applications. In the present case, this specific kernel system call handler is used to catch (i.e., “trap”) one or more pre-defined system calls called by the target application, and to pass the information on a kernel system call having been made by the target application (such as parameters of the system call, and/or an address of the instruction calling the system call) back to the loader application. In other words, the processor circuitry may intercept, by the kernel system call handler 103, the kernel system call having been made by the target application, and provide, by the kernel system call handler, the information on the kernel system call having been made by the target application to the loader application. Accordingly, as shown in FIG. 1b, the method may comprise intercepting 130, by the kernel system call handler 103, the kernel system call having been made by the target application, and providing 150, by the kernel system call handler, the information on the kernel system call having been made by the target application to the loader application. In effect, the information on the kernel system call having been made by the target application may be obtained, by the loader application, from the kernel system call handler 103. For example, the kernel system call handler may be triggered by a call hook installed in a kernel 104 being executed by the computer system. For example, the kernel system call handler 103 may process (all) incoming system calls and provide the information on the kernel system call having been made by the target application to the loader application if a system call is made by the target application and is replaceable by a corresponding operation being equivalent to the kernel system call. For example, in the Linux operating system, as will be discussed in more detail in connection with FIGS. 2 to 4, the kernel system call handler may be implemented using eBPF.

The information on the kernel system call having been made by the target application is subsequently used to modify the target application. For this purpose, it may comprise two pieces of information—information on the system call having been made, and information on a location of an instruction having made the system call. These two pieces of information may be compiled by the kernel system call handler. They may be included in the so-called context of the kernel system call. For example, the context of the kernel system call may comprise both information on the system call being made (including parameter(s) thereof) and information on a user-space application (i.e., the target application) calling the system call, including an address of (or following) an instruction having made the system call. For example, the processor circuitry may determine, based on the intercepted system call, a context of the kernel system call, and provide the information on the kernel system call having been made by the target application with information on the context of the kernel system call. Accordingly, the method (e.g., in both aspects) may comprise determining 140, by the kernel system call handler, based on the intercepted system call, the context of the kernel system call, and providing 150 the information on the kernel system call having been made by the target application with the information on the context of the kernel system call. The modification of the instruction may be done based on the context of the kernel system call.

The loader application may now use the information on the context of the kernel system call to determine, which instruction(s) of the target application are to be modified. For example, the processor circuitry may determine a position of the instruction to be modified in memory based on the context of the kernel system call. Accordingly, the method may comprise determining 170, by the loader application, a position of the instruction to be modified in memory based on the context of the kernel system call. This position, in addition to the syscall having been made (i.e., which syscall has been made), can be used to modify the target application in memory.

Using the information on the kernel system call having been made by the target application, the target application can now be modified, by the loader application, in memory. The loader application modifies, based on the information on the kernel system call having been made by the target application, an instruction of the target application. In particular, the instruction having made the system call may be modified, i.e., replaced by a modified instruction that calls an operation in the previously loaded user-space library. For this purpose, a hot-patching approach may be used. In other words, the instruction may be modified by hot-patching the target application. Hot-patching, in the context of modifying an application in user space, refers to the process of updating or patching a running application without the need to stop, restart, or otherwise disrupt the service it provides. The core idea is to make changes to the code while it is in execution, usually to apply bug fixes, security patches, or feature enhancements, in a manner that is transparent to the end-users. There are various techniques for hot-patching depending on the operating system, runtime environment, and the nature of the application being patched. In the present context, the techniques of function interposition and/or binary rewriting may be used to hot-patch the target application. Both techniques have in common that the target application is modified only in memory, i.e., the modified application is not written to disk. In effect, the instruction may be modified (only) in the launched instance of the target application.

In many cases, to provide some level of platform independence, applications generally do not explicitly call a system call. Instead, the system calls are usually called by a function that is part of an OS-dependent standard library (such as libc for the C programming language), with the application calling the function of the library. In more general terms, the instruction having made the system call (and thus to the instruction to be modified) may be part of a library that is (statically, or even dynamically) linked to the target application. In other words, an original instruction of the target application being modified by the modification may be part of a library being (statically) linked by the target application. This instruction may now be replaced by an instruction provided by a user-space library, e.g., an instruction providing equivalent access to the hardware (e.g., to networking hardware, offloading hardware, accelerator hardware etc.) as the system call. Accordingly, the modified instruction may launch an operation provided by a user-space library. The user-space library may provide access to hardware (e.g., to networking hardware, offloading hardware, accelerator hardware etc.) without requiring system calls to be made. In effect, the operation being equivalent to the kernel system call (being provided by the user-space library) may be based on a kernel bypass mechanism and may thus avoid the context switch.

Once the application is modified, the modified application uses the modified instruction instead of the original instruction, i.e., thereby triggering a user-space operation instead of a kernel-space operation. In other words, after modification of the target application, the modified instruction may be used by the target application instead of the original instruction of the target application being modified by the modification. As the target application is executed using the processor circuitry, the processor circuitry may use, when executing the target application, the modified instruction instead of the original instruction of the target application being modified by the modification. Accordingly, as further shown in FIG. 1b, the method may comprise using 190, by the target application, the modified instruction instead of the original instruction of the target application being modified by the modification.

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processor circuitry 14 or means for processing 14 may be implemented using one or more processing units, one or more processing devices, any means for processing, such as a processor, a computer or a programmable hardware component being operable with accordingly adapted software. In other words, the described function of the processor circuitry 14 or means for processing may as well be implemented in software, which is then executed on one or more programmable hardware components. Such hardware components may comprise a general-purpose processor, a Digital Signal Processor (DSP), a micro-controller, etc.

For example, the memory circuitry 16 or means for storing information 16 may a volatile memory, e.g., random access memory, such as dynamic random-access memory (DRAM).

For example, the computer system 100 may be one of a workstation computer system, a server computer system, a personal computer system, a portable computer system, a mobile device, a smartphone, a tablet computer, or a laptop computer.

More details and aspects of the apparatus 10, device 10, computer system 100, method and computer program are mentioned in connection with the proposed concept, or one or more examples described above or below (e.g., FIGS. 2 to 7). The apparatus 10, device 10, computer system 100, method and computer program may comprise one or more additional optional features corresponding to one or more aspects of the proposed concept, or one or more examples described above or below.

Various examples of the present disclosure relate to a concept for hot-patching-based syscall interception for kernel bypass mechanism with unmatched performance and universal applicability.

In order to improve performance in data center networking and storage workloads, the present disclosure provides an innovative system call interception method that is not only as efficient as dynamic linking, but can also be applied universally to all applications, regardless of whether they are statically built or rely on dynamic libraries.

In the present disclosure, example schemes are proposed for a highly performant and universal appliable system call interception mechanism, which may be implemented using a hot patching mechanism. It is capable of effectively and efficiently intercepting system calls for any programming language with unmatched performance. As a result, it can serve as a comprehensive implementation that can be applied to all appliances with high performance.

In general, there are several existing methods for implementing system call interception. For example, LD_PRELOAD may be used to pre-load a custom libc (i.e., the system library referenced by a program in the C programming language) to load an optimized version of the system call first. However, this approach is only applicable to dynamically linked applications, whereas LD_PRELOAD cannot be used with statically linked applications. For example, the Go language uses static linking for system calls, such that LD_PRELOAD cannot be applied to Go language programs. Alternatively, the “ptrace” command can be used to intercept the system call. However, since ptrace itself is a system call, a system call is used to intercept another system call, leading to an increased overhead and thus a performance degradation. Alternatively, a KVM (Kernel-based Virtual Machine), e.g., using VMX hardware visualization as provided by gvisor, may be used to intercept the system call to let it drop from a non-root context to a root context. However, if it is a hardware-based interception, the overhead is usually larger than the overhead caused by the original system call. Alternatively, Just-in-Time (JIT) or Ahead-of-Time (AOT) binary scan and translation may be used, in which the software applications are scanned and analyzed, and in which the system calls are intercepted/replaced with optimized code. However, AOT takes time before launching the program and cannot be applied to programs that generate new code at runtime. While JIT compiling can address the issue of dynamically generated code, JIT compiling is usually slow.

The present disclosure proposes an innovative system call interception mechanism that is based on hot-patching technology. Unlike static library interposition, hot patching can be used to dynamically locate an application's system call instruction context of interest in the execution path and replace it with an improved version implemented in user space library.

To keep the application un-changed, a call hook (e.g., in Linux, an eBPF hook can be used, in other OSes, a corresponding mechanism can be used) may be installed inside the kernel, which monitors the application's system call. When the system call hook identifies the system call to be intercepted, it may deliver a signal to a middleware in user space which figures out the current patch location via a system call context and patches the application instruction dynamically. As a result, system calls of interest (i.e., that can be replaced in user-space) are intercepted and the application can subsequently call the optimized user space library without any context switch afterwards.

The proposed concept provides an improved way to implement syscall (system call) interception with a reduced overhead. This scheme can provide the benefit of speeding up syscall-level binary compatible applications in implementation, e.g., by speeding up data center networking and providing storage acceleration.

This disclosure provides example methods of systems for a hot patching-based syscall interception mechanism. Various examples of the present disclosure have three key components, that is, middleware software (i.e., the loader application) denoted PAL (platform abstract layer) in the following, syscall hook (i.e., the kernel system call handler), and an eBPF loader. These components will be explained first, and then the detailed working flow in syscall interception will be explained hereafter.

FIG. 2 shows a typical binary layout in a workload in a Linux system. An application 210 calls libc 211, and inside libc, a syscall is implemented using the “syscall” instruction in a x86-64 computer system, or “int 80h” in a x86 32-bit computer system. After the syscall is triggered, a corresponding interrupt handler 221 is called in kernel space 220.

As the new loader has the full control of the application execution environment of the application 310 (shown in FIG. 3), when the syscall hook 321 delivers the current syscall context from kernel space 320, the new loader can patch the original syscall binary code (to user space code) in the statically linked libc 311 which can jump to an optimized “kernel bypass code” 330, and then return back. FIG. 3 shows a binary layout after hot patching. The patching is a one-time action, and after that, no system calls may be required anymore.

FIG. 4 shows an example hot patching flow. FIG. 4 shows a first process 410 with a statically linked application 411, a Linux PAL 412 and kernel bypass code 41. FIG. 4 further shows a second process 420 with an interception manager 421. FIG. 4 further shows a kernel 430 with a syscall hook 431.

The Platform Abstraction Layer (PAL) 412 is an abstraction layer that provides a platform level interface to an application 411, so that an application is non-intrusive and transparent to syscall interception. PAL plays a role as “loader” when an application is started. It can load the application, and control application in-memory binary executive code. After that, PAL passes the execution path to the application, and the application can start to run natively. The PAL 412 may be considered an underlying library layer of the application, and it is running in the same process space as the application 411 and has the priority to process signals (from the kernel syscall hook 431).

The syscall hook 431 is kernel space component the monitors syscalls of interest and delivers a signal to the application PAL layer 412. When the application 411 calls a syscall, normally in x86-64, a “syscall” instruction will be executed, and the execution path goes from Ring 3 to Ring 0, and the kernel takes over the execution right. The syscall hook 431 can be invoked to handle the syscall, with the syscall hook checking if the syscall is one of the syscalls configured for hot patching. If yes, then a corresponding context can be delivered to the PAL 412. The syscall hook can be a generalized method inside the kernel to take over syscall processing. For example, to provide the functionality, a proof-of-concept implementation of the proposed concept implements the syscall book using the “eBPF” mechanism in Linux. The syscall hook is programmed to listen to any syscall of interest using the eBPF “attach_kprobe” and deliver the signal via eBPF helpers.

The interception manager 421 is the control plane in the proposed concept, to provide user space configuration capability to manage the syscall interception, such as syscall identifier, process identifier and the optimized version of the user space library. It allows a user to define the syscall interception policy and may manage syscall hook components such as load/unload and update functionality. The interception manager 421 closely works with the syscall hook to provide a user defined and highly efficient syscall interception implementation. The interception manager is usually running in an independent process.

In the following, the syscall interception flow is illustrated. Based on the above component introduction, the syscall interception can be performed in the following working flow as shown in FIG. 4 as an example. In an example implementation, this working flow was implemented in Linux using eBPF as a system call monitoring mechanism. The proposed mechanism can be scaled to other operating systems with a similar mechanism.

At operation 0, the interception manager 421 loads an eBPF based syscall hook 431 inside the kernel 430. The PAL 412 loads the application 411 and registers the process ID/syscall ID etc. information with the interception manager to let the syscall hook monitor the desired syscalls. The PAL also loads the “kernel pass code” 413 in the same process. which is used to replace the existing syscall for the desired performance acceleration. The PAL 412 redirects the execution path to the application, and the application is started natively. The PAL is then set to background and can be triggered by the signal SIGILL (Signal Illegal). For example, the Linux PAL 412 may load the App 411 and kernel bypass code into memory and change the page permission as defined in the ELF (Executable and Linking Format) header.

At operation 1, at runtime of application 412, the application invokes a syscall, and execution flow goes to the kernel 430, where the syscall is trapped to the syscall hook 431.

At operation 2, the syscall hook 431 takes over the execution flow. When it identifies the trapped syscall is the one which is defined for interception, it delivers a signal SIGILL to PAL 412, which is registered by PAL in operation 0.

At operation 3, after the PAL 412 receives the signal, it locates the current application execution context, and patches the application's 411 instruction space by changing the application's behavior to invoke the “kernel bypass code” 413.

At operation 4, the PAL 412 returns from the signal processing and passes the execution flow to the application 411.

At operation 5, the application 411 executes the patched code, jumping to the “kernel bypass code” 413, which is an optimized version of the original syscall and is executed in user space only.

At operation 6, the “kernel bypass code” 413 performs the actions for the system call and returns to the application's original location to continue executing the application's further instructions. The entire flow is now user space only.

For example, in operation 3, the patch can be applied using the following design. The “kernel bypass code” 413 may expose the POSIX APIs (Application Programming Interfaces) to the application and perform the same tasks that the application expects when invoking syscalls to the kernel. The parameters of the POSIX APIs may be typically similar to the syscall interface. For example, the Kernel bypass code “sendto” defined in the header file may be:
ssize_t sendto (int sockfd, const void buf [.len], size_t len, int flags, const struct sockaddr*dest_addr, socklen_t addrlen);
   The sendto syscall definition may be:
SYSCALL_DEFINE6 (sendto, int, fd, void_user*, buff, size_t, len, unsigned int, flags, struct sockaddr_user*, addr, int, addr_len)
   It is evident that the sendto parameters are the same.

With the above operations, one or more of the following benefits may be achieved compared with other applications—the proposed concept is application agonistic, may provide improved performance by performing the patching once and running the patched version forever, and may be adapted to both statically linked and dynamically linked applications regardless of the application programming language being used.

“eBPF” is a topic of interest in networking innovation. Various examples of the proposed concept leverage this syscall interception mechanism to accelerate an unmodified application with “kernel bypass” optimization. The proposed concept is based on using a syscall hook to build a kernel bypass mechanism, trapping the execution path into kernel space just once, and, after the hot patching, there is no kernel execution anymore, so there is no kernel context switch penalty any more. Specifically, in the Linux syscall hook, the eBPF helper “bpf_send_signal” may be called when the kernel notifies the application to perform the hot-patching. The present disclosure proposes a mechanism that utilizes “syscall interception” and “hot patching” to provide a method to seamlessly accelerate an application via a kernel bypass optimization.

While a similar concept is used in Endpoint Detection and Response (EDR) as a security component, in contrast to the proposed concept, EDR continually monitors an “endpoint” to mitigate a malicious cyber threat, without patching a target application. Taking OpenEDR as example, the process monitor has similar process for injecting DLL (Dynamically Loaded Libraries) to perform process monitor as the following. OpenEDR uses an injected DLL (the library which is injected into different processes and hooks API calls) and a loader for the injected DLL—the driver component which loads injected DLL into each new process. The proposed concept also implements a new loader to load the process, which fully controls the process's CPU scheduler, memory allocation, etc. Since this loader controls everything of the process, it makes it possible to dynamically update the execution binary of the application for hot-patching (referred to as “libos” in some academic papers). In EDR, the EDR loader is only used to load the injected DLL to replace the original DLL calls, without modifying the application. The proposed concept does not focus on dynamic library hook, and instead, it is focused on static API hooks as simple pre-loading of a modified library is not feasible there. Since the API is statically linked with the original application, it is hard to differentiate from the binary code level. The proposed concept leverages syscall interception, and then locates the API binary for hot patching. After the hot-patching mechanism, there is no hook anymore. In contrast, EDR needs to continue hooking the original API.

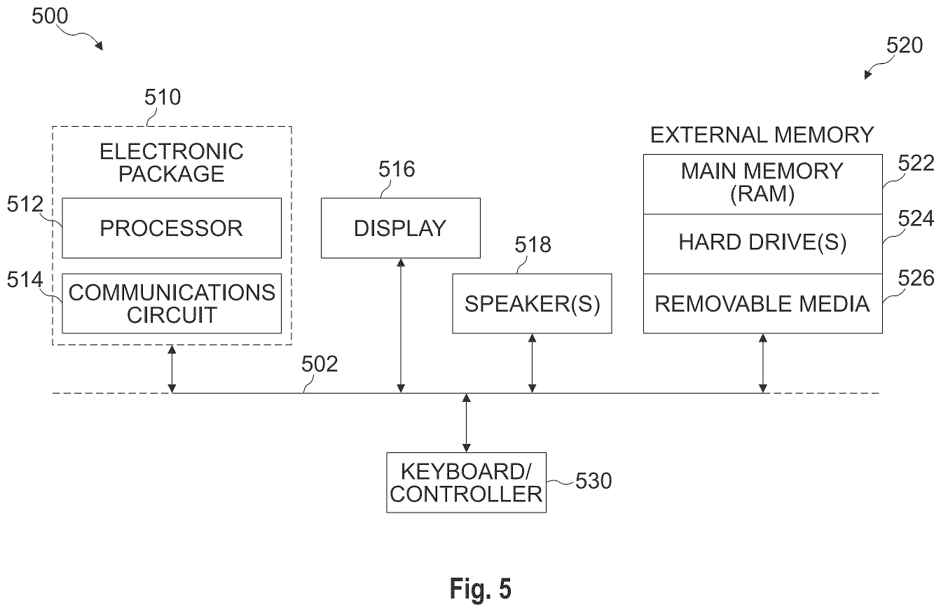

FIG. 5 is a block diagram of an electronic apparatus 500 incorporating at least one electronic assembly and/or method described herein. Electronic apparatus 500 is-merely one example of an electronic apparatus in which forms of the electronic assemblies and/or methods described herein may be used. Examples of an electronic apparatus 500 include, but are not limited to, personal computers, tablet computers, mobile telephones, game devices, MP3 or other digital music players, etc. In this example, electronic apparatus 500 comprises a data processing system that includes a system bus 502 to couple the various components of the electronic apparatus 500. System bus 502 provides communications links among the various components of the electronic apparatus 500 and may be implemented as a single bus, as a combination of busses, or in any other suitable manner.

An electronic assembly 510 as describe herein may be coupled to system bus 502. The electronic assembly 510 may include any circuit or combination of circuits. In one embodiment, the electronic assembly 510 includes a processor 512 which can be of any type. As used herein, “processor” means any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, or any other type of processor or processing circuit.

Other types of circuits that may be included in electronic assembly 510 are a custom circuit, an application-specific integrated circuit (ASIC), or the like, such as, for example, one or more circuits (such as a communications circuit 514) for use in wireless devices like mobile telephones, tablet computers, laptop computers, two-way radios, and similar electronic systems. The IC can perform any other type of function.

The electronic apparatus 500 may also include an external memory 520, which in turn may include one or more memory elements suitable to the particular application, such as a main memory 522 in the form of random-access memory (RAM), one or more hard drives 524, and/or one or more drives that handle removable media 526 such as compact disks (CD), flash memory cards, digital video disk (DVD), and the like.

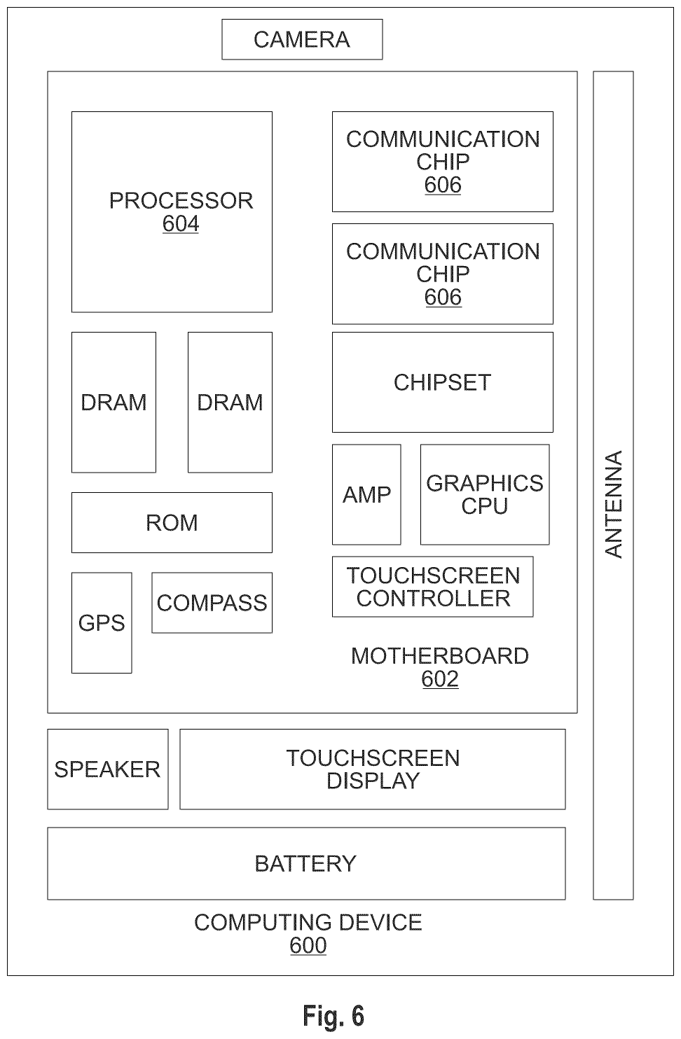

The electronic apparatus 500 may also include a display device 516, one or more speakers 518, and a keyboard and/or controller 530, which can include a mouse, trackball, touch screen, voice-recognition device, or any other device that permits a system user to input information into and receive information from the electronic apparatus 500. FIG. 6 illustrates a computing device 600 in accordance with one implementation of the invention. The computing device 600 houses a board 602. The board 602 may include a number of components, including but not limited to a processor 604 and at least one communication chip 606. The processor 604 is physically and electrically coupled to the board 602. In some implementations the at least one communication chip 606 is also physically and electrically coupled to the board 602. In further implementations, the communication chip 606 is part of the processor 604. Depending on its applications, computing device 600 may include other components that may or may not be physically and electrically coupled to the board 602. These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth). The communication chip 606 enables wireless communications for the transfer of data to and from the computing device 600. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 606 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 600 may include a plurality of communication chips 606. For instance, a first communication chip 606 may be dedicated to shorter range wireless communications such as Wi-Fi and Bluetooth and a second communication chip 606 may be dedicated to longer range wireless communications such as GPS, EDGE, GPRS, CDMA, WiMAX, LTE, Ev-DO, and others. The processor 604 of the computing device 600 includes an integrated circuit die packaged within the processor 604. In some implementations of the invention, the integrated circuit die of the processor includes one or more devices that are assembled in an ePLB or eWLB based POP package that that includes a mold layer directly contacting a substrate, in accordance with implementations of the invention. The term “processor” may refer to any device or portion of a device that processes electronic data from registers and/or memory to transform that electronic data into other electronic data that may be stored in registers and/or memory. The communication chip 606 also includes an integrated circuit die packaged within the communication chip 606. In accordance with another implementation of the invention, the integrated circuit die of the communication chip includes one or more devices that are assembled in an ePLB or eWLB based POP package that that includes a mold layer directly contacting a substrate, in accordance with implementations of the invention.

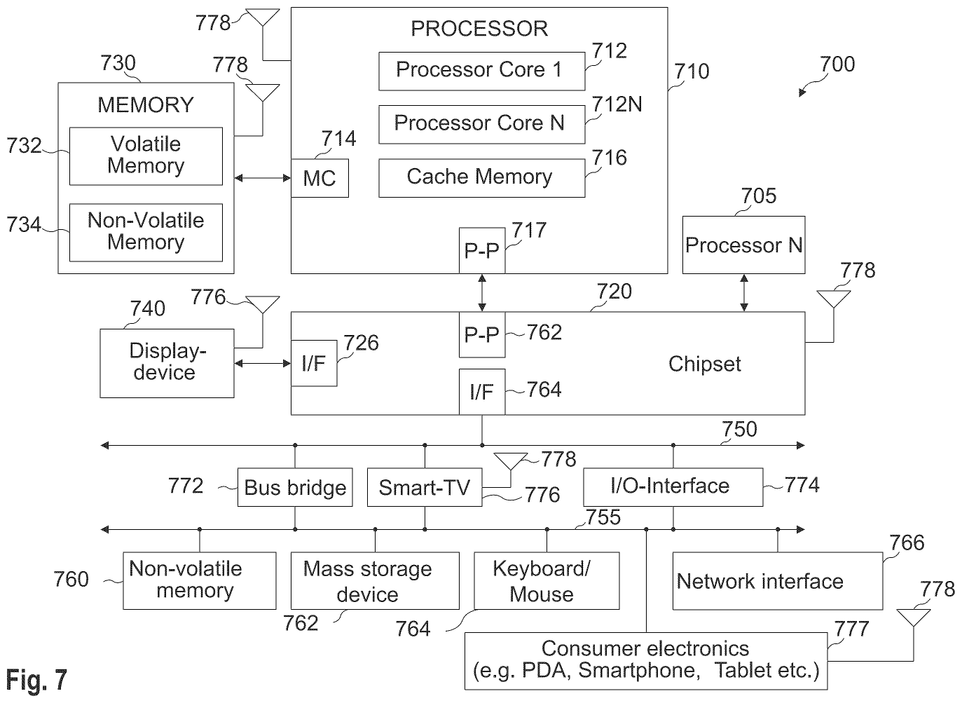

FIG. 7 is included to show an example of a higher-level device application for the disclosed embodiments. In an embodiment, a computing system 700 includes, but is not limited to, a desktop computer. In an embodiment, a system 700 includes, but is not limited to a laptop computer. In an embodiment, a system 700 includes, but is not limited to a netbook. In an embodiment, a system 700 includes, but is not limited to a tablet. In an embodiment, a system 700 includes, but is not limited to a notebook computer. In an embodiment, a system 700 includes, but is not limited to a personal digital assistant (PDA). In an embodiment, a system 700 includes, but is not limited to a server. In an embodiment, a system 700 includes, but is not limited to a workstation. In an embodiment, a system 700 includes, but is not limited to a cellular telephone. In an embodiment, a system 700 includes, but is not limited to a mobile computing device. In an embodiment, a system 700 includes, but is not limited to a smart phone. In an embodiment, a system 700 includes, but is not limited to an internet appliance.

In an embodiment, the processor 710 has one or more processing cores 712 and 712N, where 712N represents the Nth processor core inside processor 710 where N is a positive integer. In an embodiment, the electronic device system 700 using a MAA apparatus embodiment that includes multiple processors including 710 and 705, where the processor 705 has logic similar or identical to the logic of the processor 710. In an embodiment, the processing core 712 includes, but is not limited to, pre-fetch logic to fetch instructions, decode logic to decode the instructions, execution logic to execute instructions and the like. In an embodiment, the processor 710 has a cache memory 716 to cache at least one of instructions and data for the apparatus in the system 700. The cache memory 716 may be organized into a hierarchal structure including one or more levels of cache memory.

In an embodiment, the processor 710 includes a memory controller 714, which is operable to perform functions that enable the processor 710 to access and communicate with memory 730 that includes at least one of a volatile memory 732 and a non-volatile memory 734. In an embodiment, the processor 710 is coupled with memory 730 and chipset 720. The processor 710 may also be coupled to a wireless antenna 778 to communicate with any device configured to at least one of transmit and receive wireless signals. In an embodiment, the wireless antenna interface 778 operates in accordance with, but is not limited to, the IEEE 802.11 standard and its related family, Home Plug AV (HPAV), Ultra Wide Band (UWB), Bluetooth, WiMax, or any form of wireless communication protocol.

In an embodiment, the volatile memory 732 includes, but is not limited to, Synchronous Dynamic Random Access Memory (SDRAM), Dynamic Random Access Memory (DRAM), RAMBUS Dynamic Random Access Memory (RDRAM), and/or any other type of random-access memory device. The non-volatile memory 734 includes, but is not limited to, flash memory, phase change memory (PCM), read-only memory (ROM), electrically erasable programmable read-only memory (EEPROM), or any other type of non-volatile memory device.

The memory 730 stores information and instructions to be executed by the processor 710. In an embodiment, the memory 730 may also store temporary variables or other intermediate information while the processor 710 is executing instructions. In the illustrated embodiment, the chipset 720 connects with processor 710 via Point-to-Point (PtP or P-P) interfaces 717 and 722. Either of these PtP embodiments may be achieved using a MAA apparatus embodiment as set forth in this disclosure. The chipset 720 enables the processor 710 to connect to other elements in the MAA apparatus embodiments in a system 700. In an embodiment, interfaces 717 and 722 operate in accordance with a PtP communication protocol such as the Intel® QuickPath Interconnect (QPI) or the like. In other embodiments, a different interconnect may be used.

In an embodiment, the chipset 720 is operable to communicate with the processor 710, 705N, the display device 740, and other devices 772, 776, 774, 760, 762, 764, 766, 777, etc. The chipset 720 may also be coupled to a wireless antenna 778 to communicate with any device configured to at least do one of transmit and receive wireless signals.

The chipset 720 connects to the display device 740 via the interface 726. The display 740 may be, for example, a liquid crystal display (LCD), a plasma display, cathode ray tube (CRT) display, or any other form of visual display device. In and embodiment, the processor 710 and the chipset 720 are merged into a MAA apparatus in a system. Additionally, the chipset 720 connects to one or more buses 750 and 755 that interconnect various elements 774, 760, 762, 764, and 766. Buses 750 and 755 may be interconnected together via a bus bridge 772 such as at least one MAA apparatus embodiment. In an embodiment, the chipset 720 couples with a non-volatile memory 760, a mass storage device(s) 762, a keyboard/mouse 764, and a network interface 766 by way of at least one of the interface 724 and 774, the smart TV 776, and the consumer electronics 777, etc.

In an embodiment, the mass storage device 762 includes, but is not limited to, a solid-state drive, a hard disk drive, a universal serial bus flash memory drive, or any other form of computer data storage medium. In one embodiment, the network interface 766 is implemented by any type of well-known network interface standard including, but not limited to, an Ethernet interface, a universal serial bus (USB) interface, a Peripheral Component Interconnect (PCI) Express interface, a wireless interface and/or any other suitable type of interface. In one embodiment, the wireless interface operates in accordance with, but is not limited to, the IEEE 802.11 standard and its related family, Home Plug AV (HPAV), Ultra Wide Band (UWB), Bluetooth, WiMax, or any form of wireless communication protocol.

While the modules shown in FIG. 7 are depicted as separate blocks within the MAA apparatus embodiment in a computing system 700, the functions performed by some of these blocks may be integrated within a single semiconductor circuit or may be implemented using two or more separate integrated circuits. For example, although cache memory 716 is depicted as a separate block within processor 710, cache memory 716 (or selected aspects of 716) can be incorporated into the processor core 712.

The aspects and features described in relation to a particular one of the previous examples may also be combined with one or more of the further examples to replace an identical or similar feature of that further example or to additionally introduce the features into the further example.

In the following, some examples of the proposed concept are presented:

An example (e.g., example 1) relates to an apparatus (10) for a computer system (100), the apparatus comprising memory circuitry (16), machine-readable instructions, and processor circuitry (14) to execute the machine-readable instructions to launch, using a loader application (101), a target application (102), obtain, by the loader application, information on a kernel system call having been made by the target application, and modify, by the loader application and based on the information on the kernel system call having been made by the target application, an instruction of the target application, wherein the modified instruction is configured to trigger an operation being equivalent to the kernel system call, with the operation being equivalent to the kernel system call while avoiding a context switch.

Another example (e.g., example 2) relates to a previous example (e.g., example 1) or to any other example, further comprising that after modification of the target application, the modified instruction is used by the target application instead of an original instruction of the target application being modified by the modification.

Another example (e.g., example 3) relates to a previous example (e.g., example 2) or to any other example, further comprising that the processor circuitry is to execute the machine-readable instructions to use, by the target application, the modified instruction instead of the original instruction of the target application being modified by the modification.

Another example (e.g., example 4) relates to a previous example (e.g., one of the examples 1 to 3) or to any other example, further comprising that an original instruction of the target application being modified by the modification is part of a library being statically linked by the target application.

Another example (e.g., example 5) relates to a previous example (e.g., one of the examples 1 to 4) or to any other example, further comprising that the instruction is modified by hot-patching the target application.

Another example (e.g., example 6) relates to a previous example (e.g., one of the examples 1 to 5) or to any other example, further comprising that the instruction is modified in the launched instance of the target application.

Another example (e.g., example 7) relates to a previous example (e.g., one of the examples 1 to 6) or to any other example, further comprising that the modified instruction launches an operation provided by a user-space library.

Another example (e.g., example 8) relates to a previous example (e.g., one of the examples 1 to 7) or to any other example, further comprising that the operation being equivalent to the kernel system call is based on a kernel bypass mechanism.

Another example (e.g., example 9) relates to a previous example (e.g., one of the examples 1 to 8) or to any other example, further comprising that the information on the kernel system call having been made by the target application is obtained from a kernel system call handler (103).

Another example (e.g., example 10) relates to a previous example (e.g., one of the examples 1 to 9) or to any other example, further comprising that the information on the kernel system call having been made by the target application comprises a context of the kernel system call, with the modification of the instruction being based on the context of the kernel system call.

Another example (e.g., example 11) relates to a previous example (e.g., example 10) or to any other example, further comprising that the processor circuitry is to execute the machine-readable instructions to determine a position of the instruction to be modified in memory based on the context of the kernel system call.

Another example (e.g., example 12) relates to a previous example (e.g., one of the examples 1 to 11) or to any other example, further comprising that the target application is launched such that the target application shares an address space with the loader application.

Another example (e.g., example 13) relates to a previous example (e.g., one of the examples 1 to 12) or to any other example, further comprising that the processor circuitry is to execute the machine-readable instructions to intercept, by a kernel system call handler (103), the kernel system call having been made by the target application, and provide, by the kernel system call handler, the information on the kernel system call having been made by the target application to the loader application.

Another example (e.g., example 14) relates to a previous example (e.g., example 13) or to any other example, further comprising that the kernel system call handler is triggered by a call hook installed in a kernel (104) being executed by the computer system.

Another example (e.g., example 15) relates to a previous example (e.g., one of the examples 13 or 14) or to any other example, further comprising that the processor circuitry is to execute the machine-readable instruction to determine, based on the intercepted system call, a context of the kernel system call, and to provide the information on the kernel system call having been made by the target application with information on the context of the kernel system call.

An example (e.g., example 16) relates to an apparatus (10) for a computer system (100), the apparatus (10) comprising memory circuitry (16), machine-readable instructions, and processor circuitry (14) to execute the machine-readable instructions to intercept, by a kernel system call handler (103), a kernel system call having been made by a target application (102) having been launched by a loader application (102), and provide, by the kernel system call handler, information on the kernel system call having been made by the target application to the loader application.

Another example (e.g., example 17) relates to a previous example (e.g., example 16) or to any other example, further comprising that the kernel system call handler is triggered by a call hook installed in a kernel (104) being executed by the computer system.

Another example (e.g., example 18) relates to a previous example (e.g., one of the examples 16 or 17) or to any other example, further comprising that the processor circuitry is to execute the machine-readable instructions to determine, based on the intercepted system call, a context of the kernel system call, and to provide the information on the kernel system call having been made by the target application with information on the context of the kernel system call.

An example (e.g., example 19) relates to an apparatus (10) for a computer system (100), the apparatus comprising processor circuitry (14) configured to launch, using a loader application (101), a target application (102), obtain, by the loader application, information on a kernel system call having been made by the target application, and modify, by the loader application and based on the information on the kernel system call having been made by the target application, an instruction of the target application, wherein the modified instruction is configured to trigger an operation being equivalent to the kernel system call, with the operation being equivalent to the kernel system call while avoiding a context switch.

An example (e.g., example 20) relates to an apparatus (10) for a computer system (100), the apparatus comprising processor circuitry (14) configured to intercept, by a kernel system call handler (103), a kernel system call having been made by a target application (102) having been launched by a loader application (102), and provide, by the kernel system call handler, information on the kernel system call having been made by the target application to the loader application.

An example (e.g., example 21) relates to a device (10) for a computer system (100), the device comprising means for processing (14) for launching, using a loader application (101), a target application (102), obtaining, by the loader application, information on a kernel system call having been made by the target application, and modifying, by the loader application and based on the information on the kernel system call having been made by the target application, an instruction of the target application, wherein the modified instruction is configured to trigger an operation being equivalent to the kernel system call, with the operation being equivalent to the kernel system call while avoiding a context switch.

An example (e.g., example 22) relates to a device (10) for a computer system (100), the device comprising means for processing (14) for intercepting, by a kernel system call handler (103), a kernel system call having been made by a target application (102) having been launched by a loader application (102), and providing, by the kernel system call handler, information on the kernel system call having been made by the target application to the loader application.

An example (e.g., example 23) relates to a method for a computer system (100), the method comprising launching (110), by a loader application (101), a target application (102), obtaining (160), by the loader application, information on a kernel system call having been made by the target application, and modifying (180), by the loader application and based on the information on the kernel system call having been made by the target application, an instruction of the target application, wherein the modified instruction is configured to trigger an operation being equivalent to the kernel system call, with the operation being equivalent to the kernel system call while avoiding a context switch.

Another example (e.g., example 24) relates to a previous example (e.g., example 23) or to any other example, further comprising that after modification of the target application, the modified instruction is used by the target application instead of an original instruction of the target application being modified by the modification, the method comprising using (190), by the target application, the modified instruction instead of the original instruction of the target application being modified by the modification.

Another example (e.g., example 25) relates to a previous example (e.g., one of the examples 23 or 24) or to any other example, further comprising that the information on the kernel system call having been made by the target application comprises a context of the kernel system call, with the modification of the instruction being based on the context of the kernel system call, the method comprising determining (170), by the loader application, a position of the instruction to be modified in memory based on the context of the kernel system call.

Another example (e.g., example 26) relates to a previous example (e.g., one of the examples 23 to 25) or to any other example, further comprising that the method comprises intercepting (130), by a kernel system call handler (103), the kernel system call having been made by the target application, and providing (150), by the kernel system call handler, the information on the kernel system call having been made by the target application to the loader application.

Another example (e.g., example 27) relates to a previous example (e.g., example 26) or to any other example, further comprising that the method comprises determining (140), based on the intercepted system call, a context of the kernel system call, and providing (150) the information on the kernel system call having been made by the target application with information on the context of the kernel system call.

An example (e.g., example 28) relates to a method (10) for a computer system (100), the method comprising intercepting (130), by a kernel system call handler (103), a kernel system call having been made by a target application (102) having been launched by a loader application (102), and providing (150), by the kernel system call handler, information on the kernel system call having been made by the target application to the loader application.

Another example (e.g., example 29) relates to a previous example (e.g., example 28) or to any other example, further comprising that the method comprises determining (140), based on the intercepted system call, a context of the kernel system call, and providing (150) the information on the kernel system call having been made by the target application with information on the context of the kernel system call.

Another example (e.g., example 30) relates to a non-transitory, computer-readable medium comprising a program code that, when the program code is executed on a processor, a computer, or a programmable hardware component, causes the processor, computer, or programmable hardware component to perform at least one of the method of one of the examples 23 to 27 (or according to any other example). and the method of one of the examples 28 or 29 (or according to any other example).

Another example (e.g., example 31) relates to a computer system comprising at least one of the apparatuses or devices according to one of the examples 1 to 22 (or according to any other example).

Another example (e.g., example 32) relates to a computer system being configured to perform at least one of the methods according to one of the examples 23 to 27 (or according to any other example).

Another example (e.g., example 33) relates to a non-transitory machine-readable storage medium including program code, when executed, to cause a machine to perform at least one of the method of one of the examples 23 to 27 and the method of one of the examples 28 or 29.

Another example (e.g., example 34) relates to a computer program having a program code for performing at least one of the method of one of the examples 23 to 27 and the method of one of the examples 28 or 29 when the computer program is executed on a computer, a processor, or a programmable hardware component.

Another example (e.g. example 35) relates to a machine-readable storage including machine readable instructions, when executed, to implement a method or realize an apparatus as claimed in any pending claim or shown in any example.

An example (e.g., example A1) relates to a method for hot patching based syscall interception for kernel bypass mechanism according to one of examples of the specification.

An example (e.g., example A2) relates to an apparatus for hot patching based syscall interception for kernel bypass mechanism according to one of examples of the specification.

An example (e.g., example A3) relates to a system for hot patching based syscall interception for kernel bypass mechanism according to one of examples of the specification.

An example (e.g., example A4) relates to a computer program for hot patching based syscall interception for kernel bypass mechanism according to one of examples of the specification.

An example (e.g., example A5) relates to a machine-readable medium including code, when executed, to cause a machine to perform any of the methods for hot patching based syscall interception for kernel bypass mechanism according to one of examples of the specification. Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. An apparatus for a computer system, the apparatus comprising memory circuitry, machine-readable instructions, and processor circuitry to execute the machine-readable instructions to:
launch, using a loader application, a target application;
obtain, by the loader application, information on a kernel system call having been made by the target application; and
modify, by the loader application and based on the information on the kernel system call having been made by the target application, an instruction of the target application, wherein the modified instruction is configured to trigger an operation being equivalent to the kernel system call, with the operation being equivalent to the kernel system call while avoiding a context switch.

2. The apparatus according to claim 1, wherein, after modification of the target application, the modified instruction is used by the target application instead of an original instruction of the target application being modified by the modification.

3. The apparatus according to claim 2, wherein the processor circuitry is to execute the machine-readable instructions to use, by the target application, the modified instruction instead of the original instruction of the target application being modified by the modification.

4. The apparatus according to claim 1, wherein an original instruction of the target application being modified by the modification is part of a library being statically linked by the target application.

5. The apparatus according to claim 1, wherein the instruction is modified by hot-patching the target application.

6. The apparatus according to claim 1, wherein the instruction is modified in the launched instance of the target application.

7. The apparatus according to claim 1, wherein the modified instruction launches an operation provided by a user-space library.

8. The apparatus according to claim 1, wherein the operation being equivalent to the kernel system call is based on a kernel bypass mechanism.

9. The apparatus according to claim 1, wherein the information on the kernel system call having been made by the target application is obtained from a kernel system call handler.

10. The apparatus according to claim 1, wherein the information on the kernel system call having been made by the target application comprises a context of the kernel system call, with the modification of the instruction being based on the context of the kernel system call.

11. The apparatus according to claim 10, wherein the processor circuitry is to execute the machine-readable instructions to determine a position of the instruction to be modified in memory based on the context of the kernel system call.

12. The apparatus according to claim 1, wherein the target application is launched such that the target application shares an address space with the loader application.

13. The apparatus according to claim 1, wherein the processor circuitry is to execute the machine-readable instructions to intercept, by a kernel system call handler, the kernel system call having been made by the target application, and provide, by the kernel system call handler, the information on the kernel system call having been made by the target application to the loader application.

14. The apparatus according to claim 13, wherein the kernel system call handler is triggered by a call hook installed in a kernel being executed by the computer system.

15. The apparatus according to claim 13, wherein the processor circuitry is to execute the machine-readable instruction to determine, based on the intercepted system call, a context of the kernel system call, and to provide the information on the kernel system call having been made by the target application with information on the context of the kernel system call.

16. An apparatus for a computer system, the apparatus comprising memory circuitry, machine-readable instructions, and processor circuitry to execute the machine-readable instructions to:
intercept, by a kernel system call handler, a kernel system call having been made by a target application having been launched by a loader application; and
provide, by the kernel system call handler, information on the kernel system call having been made by the target application to the loader application.

17. The apparatus according to claim 16, wherein the kernel system call handler is triggered by a call hook installed in a kernel being executed by the computer system.

18. The apparatus according to claim 16, wherein the processor circuitry is to execute the machine-readable instructions to determine, based on the intercepted system call, a context of the kernel system call, and to provide the information on the kernel system call having been made by the target application with information on the context of the kernel system call.

19. A method for a computer system, the method comprising:
launching, by a loader application, a target application;
obtaining, by the loader application, information on a kernel system call having been made by the target application; and
modifying, by the loader application and based on the information on the kernel system call having been made by the target application, an instruction of the target application, wherein the modified instruction is configured to trigger an operation being equivalent to the kernel system call, with the operation being equivalent to the kernel system call while avoiding a context switch.

20. A non-transitory, computer-readable medium comprising a program code that, when the program code is executed on a processor, a computer, or a programmable hardware component, causes the processor, computer, or programmable hardware component to perform the method of claim 19.
